(19) United States
(12) Patent Application Publication
(10) Pub. No.: US 2007/0135995 A1
(43) Pub. Date: Jun. 14, 2007

(54) Mobile navigation device, control method and control program therefore

(76) Inventors: Shin Kikuchi, Tokyo (JP); Keisuke Onishi, Tokyo (JP); Yusuke Suzuki, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/576,185

(22) PCT Filed: Oct. 12, 2004
(86) PCT No.: PCT/JP04/15022

§ 371 Date: Apr. 17, 2006

(30) Foreign Application Priority Data
Oct. 17, 2003 (JP) 2003-358038

(51) Int. Cl. G01C 21/30; G05D 1/00

(52) U.S. Cl. 701/209; 701/24

(57) ABSTRACT

A navigation device having a function of dealing with a case where a navigation function cannot be executed at the same time as another function, such as a telephone function, because of constraints of the processing capability of a CPU or the memory capacity in a mobile telephone. A navigation device (10), which uses a mobile telephone having GPS means, comprises a navigation control module (123); a telephone communication control module (122) for telephone communicating with another mobile terminal device; and an operation control module (OS) (121) for controlling those modules. When detecting a particular event during operation of the navigation control module, the OS sends a suspension command to the navigation control module, thereby suspending the navigation control module. When detecting a termination of the particular event, the OS sends a resumption command to the navigation control module, thereby resuming the navigation control module.

### FIELD OF THE INVENTION

The present invention relates to a navigation device that utilizes the Global Positioning System (GPS) and more particularly, to a mobile navigation device that employs a mobile telephone, a Personal Handy-phone System (PHS) or similar telephone gadget, wherein the navigation function of the unit is suspended when a telephone call arrives and is resumed when the telephone call ends, and to a control method and a control program for such mobile navigation device. Such navigation device includes any mobile telephone, PHS or other mobile communication terminal.

### PRIOR ART

Conventionally, when people visit an unfamiliar area, they normally reach their destination by relying on an atlas or some kind of guidebook or directory for roads, landmarks and addresses shown in maps. Or, in a car equipped with a car navigation system (hereinafter, “CNS”), travelers could be assisted in reaching their destination by running the CNS upon entering their destination, obtain navigation information from the CNS guidance displayed on a monitor screen and/or delivered as audio output.

The principle of operating a CNS involves the GPS, whereby the CNS receives GPS signals transmitted from multiple GPS satellites in flight above the earth through a GPS antenna, and fixes its own position by analyzing the data on the satellites' positions, data pertaining to the distance between satellites and the receiver, as well as clock data, etc., that are contained in such GPS signals. The number of GPS satellites must be at least four. By itself, the GPS generally fixes position with an accuracy of slightly over 10 m, but with the employment of Differential GPS (DGPS), such position-fixing accuracy can be enhanced by 5 m or less.

In recent years great strides of improvement have been witnessed in the capabilities of mobile telephones, PHSs and other mobile communication terminal equipment, which are progressively becoming more multifunctional. Particularly, such equipment are now equipped with data communication functions aside from telephone communication functions, so that various kinds of data communication services are now available to their users via the Internet. One of those is the navigation service, and attempts are underway to provide not only drivers of automobiles, but also users of mobile telephones, with route guidance from their present location to reach a certain destination.

In Japanese Laid-Open Patent Publication No. 2003-28662 (see FIG. 1; hereinafter “Patent Document 1”), for example, a navigation system employing a mobile telephone with GPS capability has been disclosed. This navigation system is configured by deploying:

means for receiving GPS signals transmitted from multiple GPS satellites via a mobile telephone with GPS capability, wherein a GPS reception unit, GPS control unit and GPS antenna are built into the mobile telephone;

means for packet transmission of positional information obtained by analyzing the satellite positions, satellite-to-receiver distance data and clock information contained in the multiple GPS signals, and such data like the telephone number of the mobile telephone with GPS capability and search information, etc.; and

a map service center having means for receiving and using such data to detect the positions of the mobile telephone with GPS capability and the intended destination, and for transmitting map data including appropriate-scale map information, route information, distances, etc. to the mobile telephone with GPS capability.

The present inventors have already disclosed in Japanese Laid-Open Patent Publication No. 2003-214860 (see FIG. 1; hereinafter “Patent Document 2”) a navigation system that uses a mobile telephone as terminal. As shown in FIG. 4, this navigation system is composed of a mobile terminal (mobile telephone) 1 connected to a mobile communications network 2 and a data communication service center (information distribution computer system) 3, wherein the mobile terminal 1 receives desired data communication services by connecting to the data communication service center 3. In the case where the mobile terminal 1 is a mobile telephone or PHS, telephone calls can be made to desired recipients (fixed-line telephones, mobile telephones, PHSs, etc.) through mobile communication base stations or telephone line networks via the mobile communications network 2. As described below, the data communication service center 3 is configured so as to implement route navigation services in response to requests coming from the mobile terminal.

That is, when a route search request containing positional information on the starting point and destination is issued from the mobile terminal 1, the information distribution computer system of the data communication service center 3 uses road data stored in a storage means to find the optimal route from the starting point to the destination, and temporarily stores the data found on the route into the storage means as guidance route data. When the mobile terminal 1 makes a display map data request specifying positional coordinates and a guidance route, the information distribution computer system of the data communication service center 3 reads out from the storage means the map data for a vector-style map display of the area around the specified positional coordinates, as well as data for the specified guidance route, then converts such guidance route data into vector data for depicting roads in particular colors and incorporates such information into the map data, which are then transmitted to the mobile terminal 1, the source of the request.

The mobile terminal 1 is equipped with a GPS receiver (not shown in the drawing) for fixing the present position thereof during motion, and carries out GPS position-fixing at particular intervals. If some inadequacy occurs as indicated by the results of GPS position-fixing in the display map information, the mobile terminal 1 issues a request for display map information to the information distribution computer system of the data communication service center 3, which is provided with a storage means for storing road data (map data) and data on buildings and other landmarks, intersections and street names, etc., at various locations on the maps. Such data are updated and maintained through information distribution computer systems 5, 6 or similar systems that implement distribution of maps via an Internet network 4.

### SUMMARY OF THE INVENTION

### Problem to be Solved by the Invention

But even while continuing to improve apace, mobile telephones and PHSs (hereinafter collectively referred to as “Mobile Telephones”) are subject to certain constraints imposed by their size as would affect the capability of the control microprocessor (CPU) and storage devices that are built into them. For this reason, there are cases where the processing capability of the CPU is insufficient even though mobile telephones carry multiple applications for realizing various kinds of functions, or there is an insufficiency of resources such as storage devices for use in executing the applications. Where such insufficiency of processing capability or resources occurs, it will not be possible to execute multiple applications simultaneously via time-sharing, and measures must therefore be drawn up to deal with such problems.

Patent Documents 1 and 2 which pertain to navigation systems using a mobile telephone as terminal do not address the abovementioned problems, such that it is not possible to simultaneously operate, via time-sharing, the navigation function and another function such as telephone communication, which is the principal function of the mobile telephone. Hence, issues have remained for realizing navigation systems that operate through a mobile terminal.

Furthermore, owing to the aforementioned constraints (CPU processing capability and memory capacity, etc.), it is not possible to control telephone communication and data communication in a conventional ordinary mobile telephone simultaneously via time-sharing. When the conventional mobile telephone is operating in the data communication mode, no telephone communication mode operation is implemented, such that when a telephone call is made to the user's unit, a record of such arrival is simply stored and the base station sends a message to that effect to the call originator. Thus, when the mobile telephone is being used in the data communication mode and a telephone call is made thereto in the process of receiving navigation data, the user cannot pick up the call and would have to make a return call upon seeing the incoming call record after data communication processing ends. Hence, urgent calls are not promptly connected.

The inventors conducted numerous and various investigations and discovered that in a navigation device operating through a mobile telephone equipped with a GPS reception means, the aforementioned problem can be resolved by equipping such mobile navigation device with control means that suspends the navigation function when a telephone call arrives and resumes the navigation function upon termination of the call.

More precisely, the present invention undertakes to resolve the present problem by providing a navigation device equipped with functions to deal with the case where, owing to the constraints of the CPU processing capability and memory capacity of a mobile telephone, the navigation function cannot be simultaneously implemented with another function, such as the telephone communication function.

### Means to Resolve the Problem

The aforementioned purpose of the present invention can be achieved by means of the configuration now described below. The first mode of the present invention pertains to a mobile navigation device having:

a navigation control module that transmits a destination and a starting point via a network and/or a present position fixed via a GPS means, to an information distribution computer system, together with a request for routing guidance, and performs routing guidance on the basis of information delivered by said information distribution computer system;

a telephone communication control module for effecting telephone communication with other mobile telephones; and

an operation control module for controlling the navigation control and telephone communication control modules;

wherein:

upon detecting a particular event while the navigation control module is in operation, the operation control module sends a suspension command to the navigation control module, thereby suspending operation of the same, and

upon detecting termination of the particular event, the operation control module sends a resumption command to the navigation control module to resume operation.

In addition, in the mobile navigation device of the first mode, the particular event referred to is a telephone call coming from another mobile telephone, or constitutes a warning that the remaining power of the battery is at or below a certain level, or a warning that the system resources of the navigation device are insufficient.

Moreover, in the mobile navigation device of the first mode, the process of suspending operation of the navigation control module pertains to turning off the power supply to the GPS means, or releasing resources acquired for navigation, or stopping GPS communication.

Further, in the mobile navigation device of the first mode, the process of resuming operation of the navigation control module pertains to switching on the power supply to the GPS means, or securing resources needed for navigation, or activating GPS communication.

The control method of the first mode of the present invention is a control method for a mobile navigation device having:

a navigation control module that transmits a destination and a starting point via a network and/or a present position fixed via a GPS means, to an information distribution computer system together with a request for routing guidance, and performs routing guidance on the basis of information delivered by the information distribution computer system;

a telephone communication control module for effecting telephone communication with other mobile telephones; and

an operation control module for controlling the navigation control and telephone communication control modules;

and is a control method that comprises:

a step wherein, upon detecting a particular event while the navigation control module is in operation, the operation control module sends a suspension command to the navigation control module, thereby suspending operation of the same; and

a step wherein, upon detecting termination of the particular event, the operation control module sends a resumption command to the navigation control module to resume operation.

In addition, the mobile navigation device control method of the first mode is such that suspension of the navigation control module has the effect of turning off the power supply to the GPS means, or releasing resources acquired for navigation, or stopping GPS communication.

Moreover, the mobile navigation device control method of the first mode is such that resumption of operation of the navigation control module has the effect of turning on the power supply to the GPS means, or securing resources needed for navigation, or restarting GPS communication.

The control program of the first mode of the present invention is run in a computer device executing:

a navigation function wherein the navigation control module transmits a destination and a starting point via a network and/or present position fixed via a GPS means, to an information distribution computer system, together with a request for routing guidance, and performs routing guidance on the basis of information delivered by the information distribution computer system;

a telephone communication control function for effecting telephone communication with other mobile telephones; and

an operation control function;

and is a control program that causes such computer device to realize the function of turning off and on the GPS means, using the telephone communication control as trigger.

In addition, the control program of the first mode causes the computer device to realize the function of releasing resources acquired for navigation, or the function of stopping GPS communication when the GPS means is turned off.

Moreover, the control program of the first mode causes the computer device to realize the function of securing resources needed for navigation, or the function of starting GPS communication when the GPS means is turned on.

### Effects of the Invention

According to the mobile navigation device of the first mode of the present invention, when the mobile navigation device detects a particular event while the navigation control module is in operation, the operation control module sends a suspension command to the navigation control module to suspend the latter, and sends a resumption command thereto upon detecting termination of the particular event, thereby resuming operation of the navigation control module. Accordingly, if the particular event that occurs during navigation consists of a telephone call emanating from another mobile telephone, the navigation function is suspended, and the telephone communication function, which is the primary function of the mobile telephone, is activated and thus will not be impaired by reason of insufficient CPU processing or storage capability, etc. In addition, it will be possible for the user to pick up an urgent incoming call.

Further, according to the mobile navigation device of the first mode of the present invention, the navigation function is also suspended when a warning is issued to the effect that the remaining power of the battery power is at or below a certain level, or that the system resources of the navigation device are insufficient, owing to which, the possibility of impairing the primary function of the mobile telephone, i.e., telephone communication, can be eliminated to the greatest extent possible. Moreover, suspension of operation of the navigation control module involves turning off the power supply to the GPS means, or releasing resources, or stopping GPS communication, so that the battery's power consumption is minimized, or, where there is insufficiency in CPU processing capability or resources, impairment of the mobile telephone's primary function of telephone communication due to such insufficiency can be eliminated to the greatest extent possible. Furthermore, resumption of operation of the navigation control module involves turning on the power supply to the GPS means, or securing resources, or restarting GPS communication, so that the navigation function can smoothly resume upon termination of the particular event.

According to the control method for the mobile navigation device of the first mode of the present invention, such control method is for a mobile navigation device employing a mobile telephone having a GPS means, and comprises:

a step wherein, upon detecting a particular event while the navigation control module is in operation, the operation control module sends a suspension command to the navigation control module, thereby suspending operation of the same; and

a step wherein, upon detecting termination of the particular event, the operation control module sends a resumption command, thereby resuming operation of the navigation control module,

and in this manner a control method is provided whereby the navigation function of the navigation device is suspended when a particular event occurs such as when a telephone call emanates from another mobile telephone, thereby enabling telephone communication, which is the mobile telephone's primary function, which may otherwise be impaired by insufficient CPU processing or storage capability, etc.

Further, according to the control method for the mobile navigation device of the first mode of the present invention, a control method can be provided whereby:

the step of suspending operation of the navigation control module has the effect of turning off the power supply to the GPS means, or releasing resources, or stopping GPS communication, so that the battery's power consumption is minimized, or, where there is insufficiency in CPU processing capability or resources, impairment of the mobile telephone's primary function of telephone communication can be eliminated to the greatest extent possible;

Further still, a control method can be provided whereby:

the step of resuming operation of the navigation control module has the effect of turning on the power supply to the GPS means, or securing resources, or activating GPS communication, so that the navigation function can smoothly resume upon termination of the particular event.

According to the control program of the first mode of the present invention, the control program is run in a computer device that is a component element of the mobile navigation device and executes:

a navigation function wherein the navigation control module transmits a destination and a staring point via network and/or a present position fixed via a GPS means, to an information distribution computer system, together with a request for routing guidance, and performs routing guidance on the basis of information delivered by the information distribution computer system;

a telephone communication control function for effecting telephone communication with other mobile telephones; and

an operation control function;

whereby it is possible to cause such computer device to realize the function of turning off and on the GPS means, using the telephone communication control as trigger. In this manner, a control program can be provided for realizing the mobile navigation device of the first mode of the present invention.

Moreover, according to the control program of the first mode of the present invention, the computer device that is a component element of the mobile navigation device can be made to realize the function of releasing resources or stopping GPS communication, thereby minimizing the battery's power consumption, or, where there is insufficiency in CPU processing capability or resources, eliminates impairment of the mobile telephone's primary function of telephone communication to the greatest extent possible. Further, a control program can be provided that, by causing the computer device that is a component element of the mobile navigation device to realize the function of securing resources or commencing GPS communication, the navigation function can smoothly resume upon termination of the particular event.

### BRIEF DESCRIPTION OF THE DRAWINGS

FIG. 1 is a block diagram illustrating the configuration of a navigation device of an embodiment of the present invention.

FIG. 2 is a state transition diagram illustrating the transition of states in the navigation device of FIG. 1.

FIG. 3 is a flowchart illustrating the sequence of operations in a navigation device of an embodiment of the present invention.

FIG. 4 is a block diagram illustrating the configuration of a navigation system that uses a mobile telephone of prior art equipped with a GPS means.

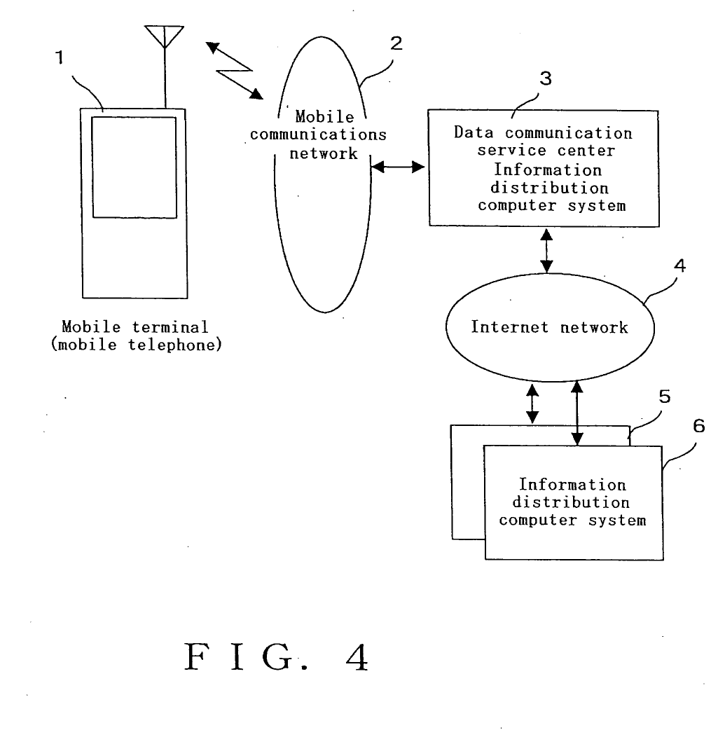

### DESCRIPTION OF THE PREFERRED EMBODIMENTS

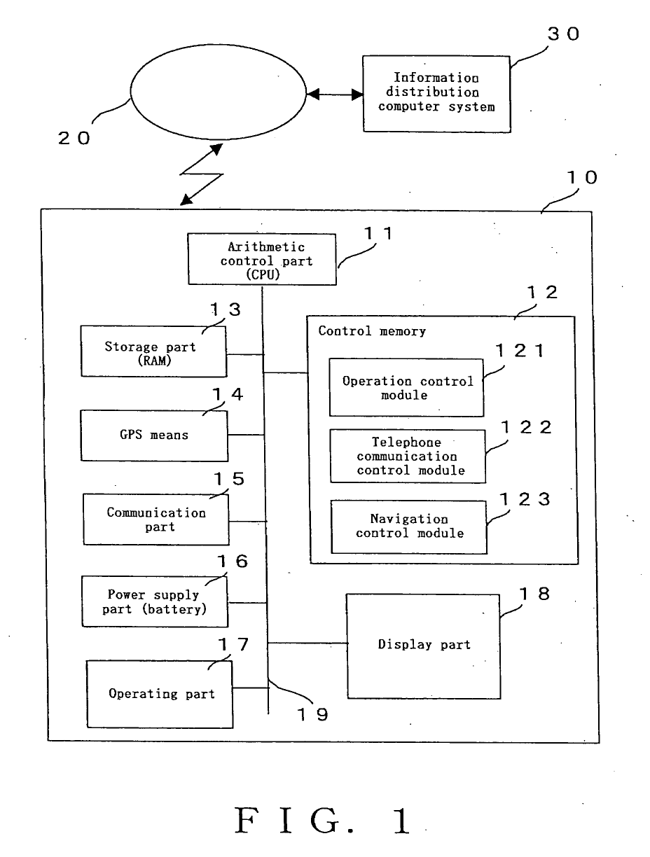

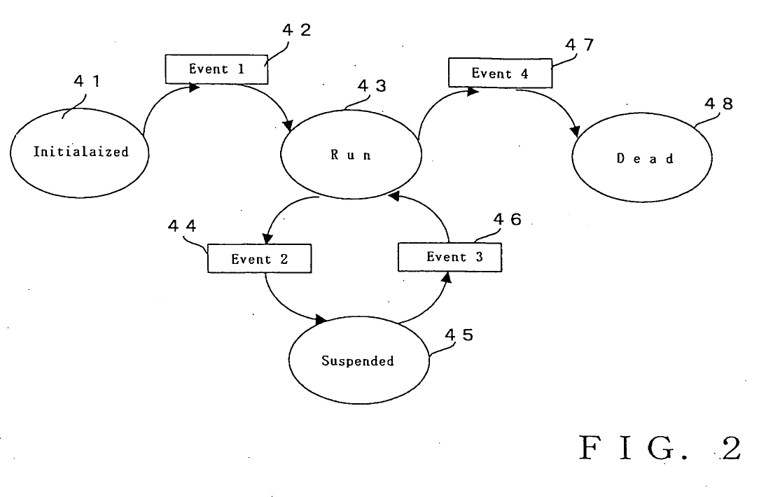

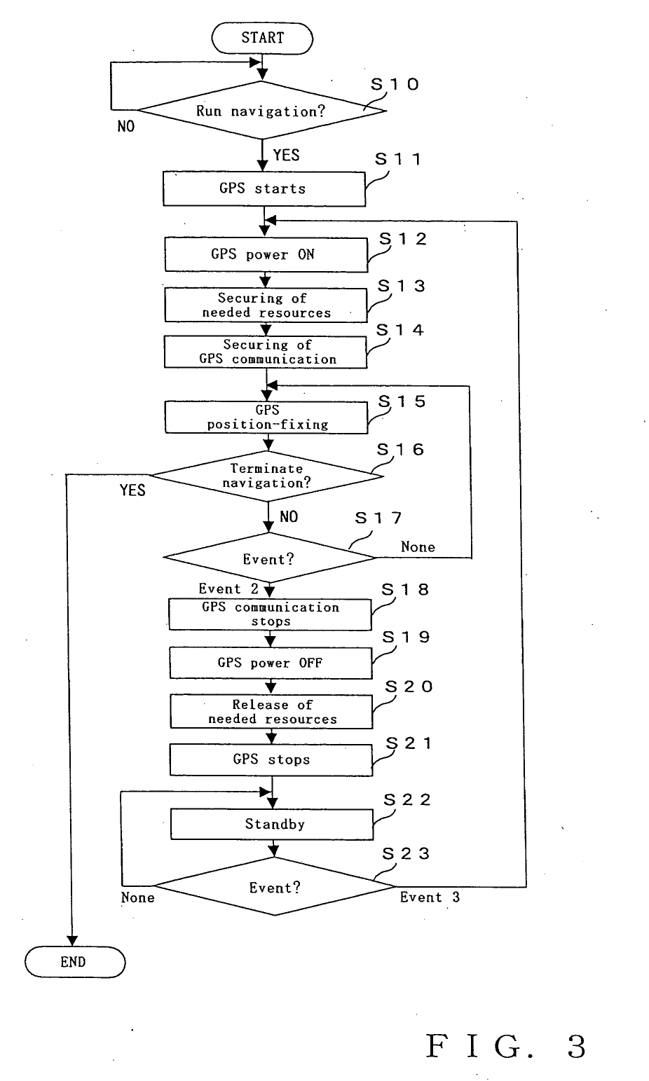

A specific illustrative embodiment of the present invention will now be described with reference to the drawings. FIG. 1 is a block diagram illustrating the configuration of a navigation device of an embodiment of the present invention, FIG. 2 is a state transition diagram illustrating the transition of states in the navigation device of FIG. 1, while FIG. 3 is a flowchart illustrating the sequence of operations in a navigation device of an embodiment of the present invention.

### Embodiment

A mobile navigation device 10 of an embodiment of the present invention consists of a mobile telephone having a GPS means, and effects telephone communication with other mobile telephones by means of a mobile communications network 20, aside from being connected to a data communication service center (information distribution computer system) 30 and receiving therefrom navigation services, as shown in FIG. 1. The scope of such navigation services will be described later. More precisely, the configuration is such that the mobile navigation device 10 can effect telephone calls with desired recipients (fixed-line telephones, mobile telephones, PHSs, etc) through mobile communication base stations or telephone line networks, via the mobile communications network 20, and the information distribution computer system 30 of the data communication service center provides route navigation services in response to requests made by the mobile navigation device 10.

The mobile navigation device 10 is configured to have as its central element an arithmetic control part (CPU) 11 consisting of microcomputers, and has a control memory 12 that contains an operation control module 121, a telephone communication control module 122, a navigation control module 123 and other control programs. The operation control module 121 is a control program that controls the operation of the mobile navigation device 10 as a whole and corresponds to the OS (operating system) of an ordinary computer device. The navigation control module, which is an application program commonly termed “a navigation application”, is incorporated into the mobile telephone in the same way as applications for other services. The operation control module 121 performs the function of an application platform that manages running and termination of applications, such as the telephone communication control module 122 and the navigation control module 123.

Further, like an ordinary mobile telephone, the mobile navigation device 10 has a storage part (RAM) 13, a communication part 15, a power supply part 16, an operating part 17 and a display part 18, and is additionally equipped with a GPS means 14 that includes a receiver for receiving GPS satellite signals. These various elements are connected to an internal bus 19 and operate under the control of the arithmetic control part 11.

The arithmetic control part 11 causes the mobile navigation device 10 to operate by executing the telephone communication control module 122, navigation control module 123 and other control programs under the control of the operation control module 121 contained in the control memory 12.

The GPS means 14 is configured to have as its central element a receiver that receives signals from multiple GPS satellites. Under the control of the navigation control module, the GPS means 14 receives signals from multiple GPS satellites at particular time intervals, uses the distances to the various satellites to compute the present position (latitude, longitude), and on the basis of such, transmits requests of various kinds to the information distribution computer system 30. Through the addition of a time element to the result of such present position computation, it is possible to compute the travel speed and direction of the mobile navigation device, which data can also be transmitted to the information distribution computer system 30. The communication part 15 in FIG. 1 is expressed as the totality of circuit functions for communication in the data communication mode and for the voice communication that is the primary function of the mobile telephone.

When, through manipulation of the operating part 17, the mobile navigation device 10 is in the standby state as an ordinary mobile telephone, the operation control module 121 will run the telephone communication control module 122, send position registration signals to the base station at particular time intervals via the communication part 15, receive control channel signals from the base station, and check whether any outside telephone calls are made to the user's telephone unit. If an outside call arrives, the operation control module 121 will carry out processing for establishing a link channel with the user's telephone unit vis-à-vis the base station, and notify the user by means of a ringtone, vibration, or an incoming call display, etc.

On the other hand, when the user gives an instruction, via manipulation of the operating part 17, for data communication such as electronic mail (e-mail) transmission/reception, the operation control module will switch the mobile navigation device 10 to the data communication mode and run the application specified via manipulation of the operating part 17. If e-mail transmission is specified, for instance, the corresponding application will be run and an e-mail drafting screen will be displayed, then an e-mail text will be prepared for transmission to the e-mail destination and the e-mail message that the user inputs to the e-mail drafting screen via the operating part 17 will be transmitted in accordance with the transmission command that is input via the operating part 17.

In a mobile telephone it is generally not possible to control telephone communication and data communication simultaneously via time-sharing, owing to constraints imposed by the processing capability of the arithmetic control part (CPU) 11 or the capacity of the storage part (RAM), etc. Consequently, when the mobile telephone is operating in the data communication mode, no telephone communication mode operation can be carried out, and if a telephone call is made to the user's phone, a record of such arrival is simply maintained while the base station sends the call originator a message to the effect that packet communication is in progress. According to such control, if a telephone call arrives while the mobile navigation device 10 is operating while connected to the information distribution computer system 30 so as to receive navigation services, the user cannot be informed of the call until the function of navigation terminates. Reception of navigation services will usually last until the destination is reached, so that the user is not apprised of any incoming calls for some time, even if they are urgent.

In the present embodiment, as will now be described, when a telephone call made another mobile telephone arrives, the navigation function is suspended so that the call can be answered. Specifically, when an instruction to use the navigation service is input by the user via manipulation of the operating part 17, the operation control module 121 runs the navigation control module 123, which initially displays a screen for inputting the conditions needed for navigation, such as the starting point or present location and the destination, and then the user inputs the desired information.

When a route search request including positional information on the starting point and destination is issued from the mobile navigation device 10, the information distribution computer system 30 uses road data stored in a storage means to find the optimal route from the starting point to the destination, and temporarily stores the retrieved route data into the storage means as guidance route data. When the mobile navigation device 10 makes a display map data request specifying positional coordinates and a guidance route, the information distribution computer system 30 reads out from the storage means the map data for a vector-style map display of the area around the positional coordinates specified, and data for the specified guidance route, then converts such guidance route data into vector data for depicting roads in particular colors, incorporates such into the map data, and transmits such map data to the mobile navigation device 10, which is the source of the request. The information distribution computer system 30 also sends data pertaining to intersections and other guiding points along the route to the mobile navigation device 10.

The mobile navigation device 10 temporarily stores in the storage part 13 the aforementioned data received from the information distribution computer system 30, and displays the map and route in the display part 18. At particular time intervals the mobile navigation device 10 carries out GPS position-fixing, obtaining present position information therefrom. The map, route and other images displayed in the display part 18 are automatically scrolled relative to the present position of the mobile navigation device 10, in step with the traveling motion of the user.

When a telephone call made another mobile telephone arrives at the mobile navigation device 10 during navigation operation, the operation control module 121 detects such event occurrence and sends a suspension command to the navigation control module 123. Upon receiving such command, the navigation control module 123 carries out suspension processing so as to temporarily halt any further navigation processing. Such suspension processing includes processing for turning off the GPS means 14, as will be described later. When the operation control module 121 detects, as an event, the termination of the telephone call, the operation control module 121 sends a resumption command to the navigation control module 123. Upon receiving such command, the navigation control module 123 carries out resumption processing so as to resume the navigation function that was temporarily interrupted. Such resumption processing includes processing for turning on the GPS means 14, as will be described later.

FIG. 2 shows the state of transitions of the mobile navigation device 10 in the course of the above-described suspension and resumption of navigation. Namely, before the operation control module 121 runs the navigation control module 123, the navigation control module 123 is in the Initialized state 41. Upon the occurrence (detection) of event 1 (reference numeral 42), which refers to the detection of input of a navigation operation instruction by the user (via manipulation of the operating part 17), the operation control module 121 runs the navigation control module 123, and the navigation control module 123 is put into the Run state 43.

The operation during execution of the navigation control module 123 proceeds as described earlier. During such time, if the operation control module 121 detects an event 2 (reference numeral 44), the operation control module 121 sends a suspension command to the navigation control module 123. Upon receiving such command, the navigation control module 123 carries out suspension processing, thereby effecting suspension (temporary halt) 45 of any further processing. A typical instance of event 2 is the arrival of a telephone call made from another mobile telephone at the mobile navigation device 10. Upon detecting such a call, the operation control module 121 will send a suspension command as aforementioned.

Upon detecting event 3 (reference numeral 46), which in the present case is the termination of the telephone call, the operation control module 121 sends a resumption command to the navigation control module 123. Upon receiving such command, the navigation control module 123 carries out resumption processing, thereby resuming execution of navigation (Run state, reference numeral 43). When the operation control module 121 detects event 4 (reference numeral 47), which refers to the termination of navigation (the destination being reached, or termination manipulation being performed via the operating part 17), the navigation control module 123 carries out termination processing and enters the terminated/stopped (Dead) state (reference numeral 48).

The sequence of suspension and resumption processing of the navigation control module 123 will be described hereafter with reference to the flowchart in FIG. 3. When the operation control module 121 detects input of a navigation operation instruction (event 1), a run command is sent to the navigation control module 123 (step S10). The navigation control module 123 starts execution in response to such run command, and by virtue of step S11, starts position-fixing via the GPS means 14, as previously described. More precisely, in step S12, the power supply is turned on to the GPS means 14, then in step S13 the necessary resources are secured in such ways as obtaining in the storage part 13 the memory area needed for the operation. Then in step S14 the present position data determined is transmitted to the information distribution computer system 30 or communication links for receiving data for maps, routes, guiding points and guidance, etc., are secured from the information distribution computer system, and in step S15 the positioning data is transmitted to the information distribution computer system 30 and the navigation services described earlier are thus performed.

When the operation control module 121 detects termination of navigation (event 4) and a termination command is sent to the navigation control module 123 (step S16), the navigation control module 123 carries out termination processing. If there is no termination command in step S16, and the operation control module 121 detects no telephone call arrival (event 2) from another mobile telephone (step S17), the navigation control module 123 returns to step S15, transmits position-fixing data to the information distribution computer system 30 at particular time intervals, and continues navigation.

If the operation control module 121 detects a telephone call arrival from another mobile telephone (event 2) and a suspension command is sent to the navigation control module 123 (step S17), the navigation control module 123 carries out suspension processing upon receiving such suspension command in the following sequence. Namely, the navigation control module 123 ceases communication with the information distribution computer system 30 (releases the communication links) in step S18, turns off the power supply to the GPS means 14 (turns off the GPS means 14) in step S19, releases the earlier-secured needed resources such as memory, etc., in step S20, stopping the positioning data transmission and other GPS functions in step S21, then enters the standby state in step S22.

Such standby state will continue for as long as the operation control module 121 does not detect termination of the telephone call (event 3). When the operation control module 121 detects termination of the telephone call and sends a resumption command to the navigation control module 123 (step S23), the navigation control module 123 carries out resumption processing and resumes navigation. More precisely, the navigation control module 123 returns to step S12, turning on the power supply to the GPS means 14 (turning on the GPS means 14), then in step S13 secures the necessary resources in such ways as retrieving from in the storage part 13 the memory area needed for the operation, while transmitting in step S14 the present position data determined by the GPS means 14 to the information distribution computer system 30 or secures communication links for receiving data for maps, routes, guiding points and guidance, etc., from the information distribution computer system. In step S15, the navigation control module 123 transmits positioning data to the information distribution computer system 30 and resumes the navigation services.

Thus, according to the present invention, if the mobile navigation device 10 receives a telephone call from another mobile telephone during navigation operation, operation of the navigation control module 123 is suspended, being resumed upon termination of the telephone call. As a result, the mobile telephone's primary function of telephone communication will not be impaired by insufficiency in CPU processing or storage capability, etc. Furthermore, should the telephone call be urgent, it can be answered immediately.

If required, when the process of suspending the navigation control module 123 is executed in the foregoing embodiment, in order to shelter the interrupted navigation data, which will be required for resumption, it will be possible to provide for a sheltering area in the storage part 13 and shelter the data there, or to send a suspension notification to the information distribution computer system 30 and have the information distribution computer system 30 save the necessary data. In addition, where the mobile navigation device 10 travels a large distance during suspension of navigation, in that there is large divergence between the initial routing guidance and guiding points (intersections, etc), then the information distribution computer system 30 will re-perform route searching, etc., after resumption and thereafter transmit new navigation data to the mobile navigation device 10.

Furthermore, although the operation control module 121 and the telephone communication control module 122 have been described as separate modules in the embodiment, it will be possible in the case of a mobile telephone to configure the functions of the operation control module 121 and the functions of the telephone communication control module 122 as an integrated mobile telephone control module.

Moreover, although the event that causes the navigation control module 123 to pass from the state of suspension to the state of resumption during operation has been described above in relation to a telephone call being made to the user's unit from another mobile telephone, the present invention is not limited to such event (cause). Suspension of the navigation control module 123 can also be triggered by another event, for example, detection of a warning that the remaining power of the battery 16 is at or below a certain level, or of a warning that the system resources of the mobile navigation device 10 are insufficient, with the navigation control module 123 being resumed once such event terminates or such cause is resolved. In this way, impairment of the primary function of the mobile navigation device 10 as a mobile telephone, which is to provide telephone communication, can be eliminated to the greatest extent possible.

What is claimed is:

1. A mobile navigation device comprising:
a navigation control module that transmits a destination and a starting point via a network and/or a present position fixed via a GPS means, to an information distribution computer system, together with a request for routing guidance, and performs routing guidance on the basis of information delivered by the information distribution computer system;
a telephone communication control module for effecting telephone communication with other mobile telephones; and
an operation control module for controlling the navigation control and telephone communication control modules;
and wherein:
upon detecting a particular event while the navigation control module is in operation, the operation control module sends a suspension command to the navigation control module, thereby suspending operation of the same; and
upon detecting termination of the particular event, the operation control module sends a resumption command to the navigation control module to resume operation.

2. The mobile navigation device according to claim 1, wherein the particular event referred to is a telephone call coming from another mobile telephone.

3. The mobile navigation device according to claim 1, wherein the particular event consists of a warning that the remaining power of the battery is at or below a certain level.

4. The mobile navigation device according to claim 1, wherein the particular event consists of a warning that the system resources of the navigation device are insufficient.

5. The mobile navigation device according to claim 1, wherein the power to the GPS means is turned off in the process of suspending operation of the navigation control module.

6. The mobile navigation device according to claim 1, wherein resources acquired for navigation are released in the process of suspending operation of the navigation control module.

7. The mobile navigation device according to claim 1, wherein GPS communication is stopped in the process of suspending operation of the navigation control module.

8. The mobile navigation device according to claim 1, wherein the power to the GPS means is turned on in the process of resuming operation of the navigation control module.

9. The mobile navigation device according to claim 1, wherein resources needed for navigation are acquired in the process of resuming operation of the navigation control module.

10. The mobile navigation device according to claim 1, wherein GPS communication commences in the process of resuming operation of the navigation control module.

11. A control method for a mobile navigation device comprising:
a navigation control module that transmits a destination and a starting point via a network and/or a present position fixed via a GPS means, to an information distribution computer system, together with a request for routing guidance, and performs routing guidance on the basis of information delivered by the information distribution computer system;
a telephone communication control module for effecting telephone communication with other mobile telephones; and
an operation control module for controlling the navigation control and telephone communication control modules;
and being a control method comprising:
a step wherein, upon detecting a particular event while the navigation control module is in operation, the operation control module sends a suspension command to the navigation control module, thereby suspending operation of the same; and
a step wherein, upon detecting termination of the particular event, the operation control module sends a resumption command to the navigation control module to resume operation.

12. The mobile navigation device control method according to claim 11, wherein the power supply to the GPS means is turned off in the process of suspending the navigation control module.

13. The mobile navigation device control method according to claim 11, wherein resources acquired for navigation are released in the process of suspending operation of the navigation control module.

14. The mobile navigation device control method according to claim 11, wherein GPS communication is stopped in the process of suspending operation of the navigation control module

15. The mobile navigation device control method according to claim 11, wherein the power supply to the GPS means is turned on in the process of resuming operation of the navigation control module.

16. The mobile navigation device control method according to claim 11, wherein GPS communication commences in the process of resuming operation of the navigation control module.

17. The mobile navigation device control method according to claim 11, wherein resources needed for navigation are acquired in the process of resuming operation of the navigation control module.

18. A control program for a computer device comprising:
a navigation function wherein the navigation control module transmits a destination and a starting point via a network and/or a present position fixed via a GPS means, to an information distribution computer system, together with a request for routing guidance, and performs routing guidance on the basis of information delivered by the information distribution computer system;
a telephone communication control function for effecting telephone communication with other mobile telephones; and
an operation control function,
being a control program that causes such computer device to realize the function of turning off and on the GPS means, using the telephone communication control as trigger.

19. The control program according to claim 18, wherein the computer device is made to realize the function of releasing resources acquired for navigation when the GPS means is turned off.

20. The control program according to claim 18, wherein the computer device is made to realize the function of stopping GPS communication when the GPS means is turned off.

21. The control program according to claim 18, wherein the computer device is made to realize the function of commencing GPS communication when the GPS means is turned on.

22. The control program according to claim 18, wherein the computer device is made to realize the function of acquiring resources needed for navigation when the GPS means is turned on.
